(19) United States
(12) Patent Application Publication
(10) Pub. No.: US 2019/0140990 A1
(43) Pub. Date: May 9, 2019

(54) GENERATING A SELECTABLE RESPONSE TO AN ELECTRONIC MESSAGE

(71) Applicant: Gfycat, Inc., Palo Alto, CA (US)

(72) Inventors: Richard RABBAT, Palo Alto, CA (US); Hanna XU, Sunnyvale, CA (US); Yin ZHU, San Jose, CA (US)

(73) Assignee: Gfycat, Inc., Palo Alto, CA (US)

(21) Appl. No.: 15/803,681

(22) Filed: Nov. 3, 2017

(51) Int. Cl. H04L 12/58; G06F 17/30

(52) U.S. Cl. CPC H04L 51/08; G06F 3/0482; H04L 51/04; G06F 17/30058

(57) ABSTRACT

In a computer-implemented method for generating a selectable response to an electronic message, a selection of a media file from a plurality of media files to transmit to a recipient is received at an electronic device. At least one responsive media file to transmit to the recipient is determined, wherein the at least one responsive media file is based at least in part on the selected media file. An electronic message is transmitted to the recipient, the electronic message comprising the selected media file and the at least one responsive media file, wherein the at least one responsive media file is selectable within the electronic message by the recipient for transmission to a sender of the electronic message.

### BACKGROUND

In recent years, mobile electronic devices, such as cell phones and smart phones, have become ubiquitous sources of communication. For instance, mobile electronic devices used for voice communication, text messaging, electronic mail (email), file sharing, etc. Moreover, text messaging applications are increasingly being used to communicate media files, such as Graphics Interchange Format (GIF) files.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 illustrates an example computer system upon which embodiments described herein may be implemented.

FIG. 2 illustrates an example network upon which embodiments described herein may be implemented.

FIG. 3 illustrates a table including example media file categories and response categories, in accordance with various embodiments.

FIG. 4A illustrates an example screen shot of a graphical user interface for accessing media file library, according to one embodiment.

FIG. 4B illustrates an example screen shot of a messaging application including a graphical user interface for accessing media file library, according to one embodiment.

FIG. 5 illustrates an example screen shot of a messaging application displaying an electronic message including a selected media file and two responsive media files, according to one embodiment.

FIG. 6 illustrates a flow diagram of an example method for generating a selectable response to an electronic message, according to various embodiments.

FIG. 7 illustrates a flow diagram of an example method for determining a responsive media file to transmit to a recipient, according to various embodiments.

### DESCRIPTION OF EMBODIMENTS

The following Description of Embodiments is merely provided by way of example and not of limitation. Furthermore, there is no intention to be bound by any expressed or implied theory presented in the preceding background or brief summary, or in the following detailed description.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### NOTATION AND NOMENCLATURE

Some portions of the detailed descriptions which follow are presented in terms of procedures, logic blocks, processing and other symbolic representations of operations on data within an electrical circuit. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “determining,” “transmitting,” “providing,” “selecting,” “presenting,” or the like, refer to the actions and processes of an electronic device such as: a processor, a memory, a computing system, a mobile electronic device, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example fingerprint sensing system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### OVERVIEW OF DISCUSSION

Discussion begins with a description of an example computer system upon which embodiments of the present invention may be implemented. Example selection and transmission of selectable responsive media files for inclusion in an electronic message including a media file is then described. Example operations of generating a selectable response to an electronic message and determining a responsive media file to transmit to the recipient are then described.

In accordance with various embodiments, methods for generating a selectable response to an electronic message are provided. A selection of a media file from a plurality of media files to transmit to a recipient is received at an electronic device. At least one responsive media file to transmit to the recipient is determined, wherein the at least one responsive media file is based at least in part on the selected media file. An electronic message is transmitted to the recipient, the electronic message comprising the selected media file and the at least one responsive media file, wherein the at least one responsive media file is selectable within the electronic message by the recipient for transmission to a sender of the electronic message.

Embodiments described herein pertain to the transmission of electronic messages including media files. Messaging applications are available for communication between users on many computer systems, such as mobile electronic devices. For example, Apple's iOS Messages, also known as iMessage, is the native messaging application available in Apple's iPhone and iPad product line. Many different messaging applications exist, and can be native to a device, native to an operating system, or third-party applications. Examples of other messaging applications include, but are not limited to: Android Messages, Facebook Messenger, . . . . It should be appreciated that embodiments described herein may be implemented within any messaging application that allows for the transmission of electronic messages and media files, and is not intended to be limited to any particular messaging application.

Embodiments described herein pertain to selecting and transmitting selectable responsive media files for inclusion in an electronic message including a media file. In one embodiment, the media files are Graphics Interchange Format (GIF) files. While embodiments described herein pertain to GIF files, it should be appreciated that other types of media files, such as other types of video files and audio files, can be used herein. Moreover, it should be appreciated that any type of media file format can be used in accordance with the described embodiments, including but not limited to GIF, WebM, WebP, MPEG-4 (MP4), Animated Portable Network Graphics (APNG), Motion JPEG, Flash video (FLV), Windows Media video, M4V, MPEG-1 or MPEG-2 Audio Layer III (MP3), etc.

In accordance with some embodiments, a selection of a media file by a user (e.g., sender) is received for transmission to another user (e.g., recipient). In some embodiments, media files are maintained in a library of media files. For example, a user may access a library of media files via a graphical user interface of an electronic device. In some embodiments, access to the library of media files is accessible via a messaging application of an electronic device (e.g., a computer system or a smart phone).

In various embodiments, media files are associated with at least one category (e.g., a word, sentence, or phrase) that identifies the subject matter of the media files. Categories are used for sorting media files within the library of media files, allowing a user to locate or select a particular media file according to their desired message. It should be appreciated that a category associated with a media file can be assigned manually or automatically, and are generally indicative of the depiction presented in the media file. In some embodiments, a category (or categories) associated with a media file may be saved as metadata of the media file. In some embodiments, a category (or categories) associated with a media file may be saved within the library of media files.

For example, a video media file depicting a person blowing out candles on a birthday cake might be associated with the category “Happy Birthday.” Other media files depicting birthday messages (e.g., a video of a movie scene with an actor making a toast accompanied with the caption “Happy Birthday!,” or an audio clip of Marilyn Monroe's famous singing of the Happy Birthday Song to President John F. Kennedy) may also be associated with the category “Happy Birthday.” It should be appreciated that a media file may be associated with multiple categories. For example, a media file of a hamster wearing a birthday hat may be associated with the “Happy Birthday” category, as well other categories such as “Animals,” “Hamsters,” or others.

A recipient of a media file may wish to respond to the sender with another media file that is responsive to the media file of the sender. For example, a recipient of a media file depicting a birthday greeting message may wish to respond with a media file depicting thanks. Embodiments described herein provide for determining at least one responsive media file to the sender's media file. In some embodiments, the responsive media files are determined based on the category of the selected media file.

In accordance with some described embodiments, the categories of media files are also associated with response categories of media files. A response category is a category of media files that are most likely responsive to a media file of a particular category. For example, where a category of a sent media file is “Happy Birthday,” a response category might be “Thanks” or “Thumbs Up.” It should be appreciated that the defining of categories and response categories may be subjectively determined by a designer/administrator, and that relationships between categories and response categories may be user-defined. It should also be appreciated that a learning system may determine the relationships between categories and response categories based on past messages between users in the messaging application. Some media files are also associated with a response category. It should be appreciated that a media file may be associated with more than one response category. Moreover, it should be appreciated that a media file might be associated with a category or categories and a response category or categories.

An electronic message for transmission to the recipient is generated, where the electronic message includes the selected media file, as well as at least one responsive media file that is based on the selected media file. In some embodiments, responsive media files are determined based on the category of the selected media file. The electronic message is transmitted to the recipient, where the responsive media files included in the electronic message are selectable for transmission to the sender of the electronic message.

### Example Computer System

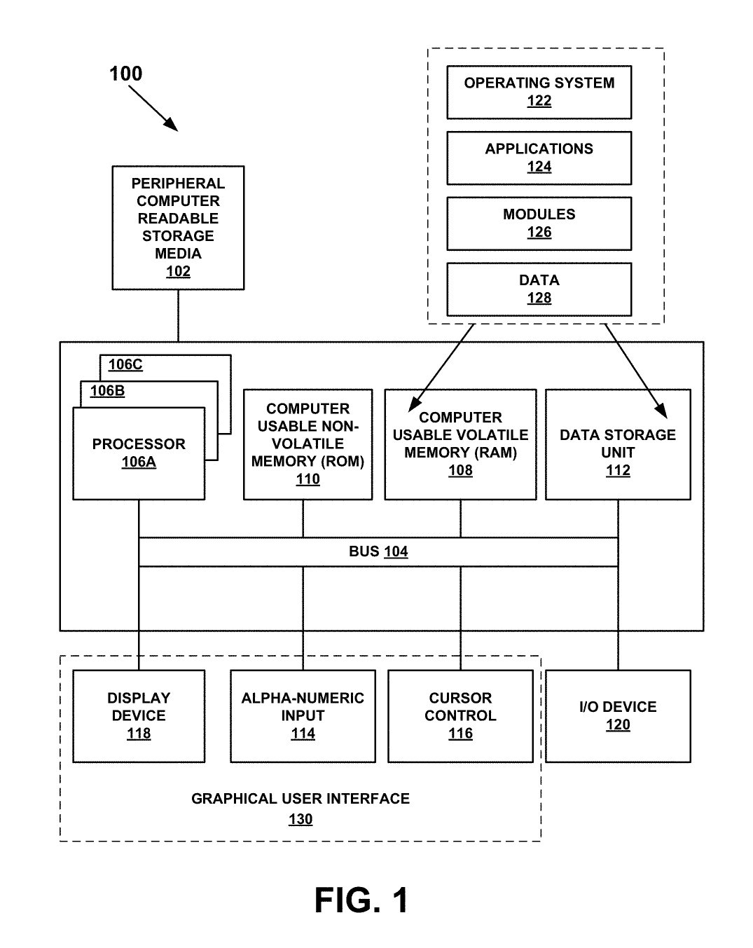

Turning now to the figures, FIG. 1 is a block diagram of an example computer system 100 upon which embodiments of the present invention can be implemented. FIG. 1 illustrates one example of a type of computer system 100 (e.g., a computer system) that can be used in accordance with or to implement various embodiments which are discussed herein.

It is appreciated that computer system 100 of FIG. 1 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, stand alone computer systems, media centers, handheld computer systems, multi-media devices, and the like. In some embodiments, computer system 100 of FIG. 1 is well adapted to having peripheral tangible computer-readable storage media 102 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 100 of FIG. 1 includes an address/data bus 104 for communicating information, and a processor 106A coupled with bus 104 for processing information and instructions. As depicted in FIG. 1, computer system 100 is also well suited to a multi-processor environment in which a plurality of processors 106A, 106B, and 106C are present. Conversely, computer system 100 is also well suited to having a single processor such as, for example, processor 106A. Processors 106A, 106B, and 106C may be any of various types of microprocessors. Computer system 100 also includes data storage features such as a computer usable volatile memory 108, e.g., random access memory (RAM), coupled with bus 104 for storing information and instructions for processors 106A, 106B, and 106C. Computer system 100 also includes computer usable non-volatile memory 110, e.g., read only memory (ROM), coupled with bus 104 for storing static information and instructions for processors 106A, 106B, and 106C. Also present in computer system 100 is a data storage unit 112 (e.g., a magnetic or optical disc and disc drive) coupled with bus 104 for storing information and instructions. Computer system 100 also includes an alphanumeric input device 114 including alphanumeric and function keys coupled with bus 104 for communicating information and command selections to processor 106A or processors 106A, 1066, and 106C. Computer system 100 also includes an cursor control device 116 coupled with bus 104 for communicating user input information and command selections to processor 106A or processors 106A, 106B, and 106C. In one embodiment, computer system 100 also includes a display device 118 coupled with bus 104 for displaying information.

Referring still to FIG. 1, display device 118 of FIG. 1 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 116 allows the computer user to dynamically signal the movement of a visible symbol (cursor) on a display screen of display device 118 and indicate user selections of selectable items displayed on display device 118. Many implementations of cursor control device 116 are known in the art including a trackball, mouse, touch pad, touch screen, joystick or special keys on alphanumeric input device 114 capable of signaling movement of a given direction or manner of displacement. Alternatively, it will be appreciated that a cursor can be directed and/or activated via input from alphanumeric input device 114 using special keys and key sequence commands. Computer system 100 is also well suited to having a cursor directed by other means such as, for example, voice commands. In various embodiments, alphanumeric input device 114, cursor control device 116, and display device 118, or any combination thereof (e.g., user interface selection devices), may collectively operate to provide a graphical user interface (GUI) 130 under the direction of a processor (e.g., processor 106A or processors 106A, 106B, and 106C). GUI 130 allows user to interact with computer system 100 through graphical representations presented on display device 118 by interacting with alphanumeric input device 114 and/or cursor control device 116.

Computer system 100 also includes an I/O device 120 for coupling computer system 100 with external entities. For example, in one embodiment, I/O device 120 is a modem for enabling wired or wireless communications between computer system 100 and an external network such as, but not limited to, the Internet. In one embodiment, I/O device 120 includes a transmitter. Computer system 100 may communicate with a network by transmitting data via I/O device 120.

Referring still to FIG. 1, various other components are depicted for computer system 100. Specifically, when present, an operating system 122, applications 124, modules 126, and data 128 are shown as typically residing in one or some combination of computer usable volatile memory 108 (e.g., RAM), computer usable non-volatile memory 110 (e.g., ROM), and data storage unit 112. In some embodiments, all or portions of various embodiments described herein are stored, for example, as an application 124 and/or module 126 in memory locations within RAM 108, computer-readable storage media within data storage unit 112, peripheral computer-readable storage media 102, and/or other tangible computer-readable storage media.

### Example Network and System for Automatically Generating Selectable Responses to an Electronic Message

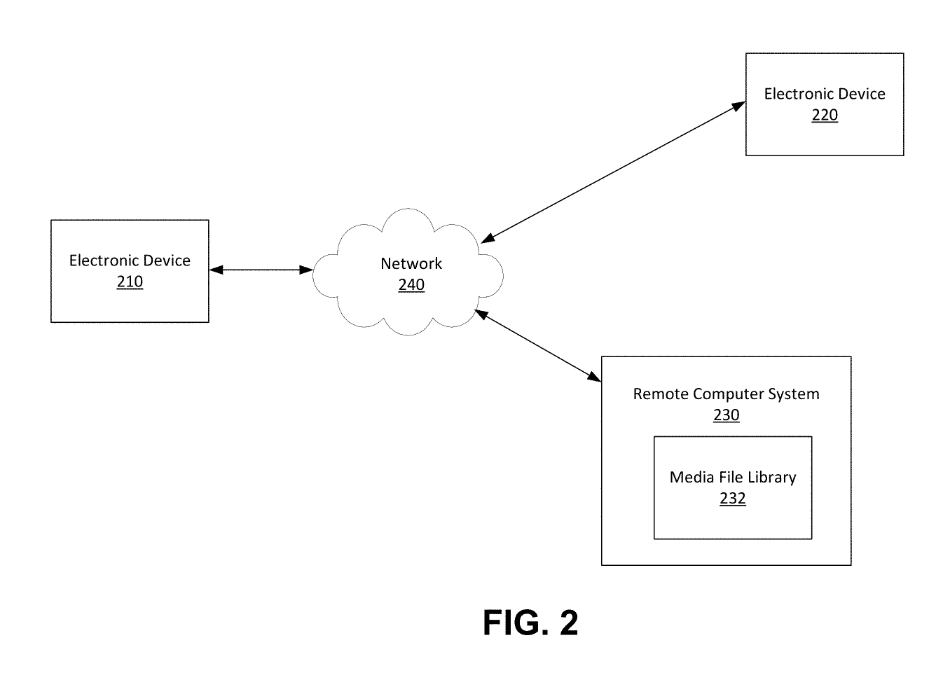

FIG. 2 illustrates an example communication network 240 upon which embodiments described herein may be implemented. FIG. 2 illustrates electronic device 210, electronic device 220, and remote computer system 230, all of which are communicatively coupled via network 240. It should be appreciated that electronic device 210, electronic device 220, and remote computer system 230, may be implemented as a computer system 100, and/or include any combination of the components of computer system 100 in which electronic device 210 and electronic device 220 are able to communicate with each other. In some embodiments, electronic device 210 and electronic device 220 are mobile electronic devices (e.g., smart phones) including messaging applications for communicating electronic messages via a graphical user interface.

In accordance with various embodiments, electronic devices 210 and 220 are capable of transmitting and receiving electronic messages including media files. The media files are capable of being rendered on electronic devices 210 and 220. In some embodiments, electronic devices 210 and 220 are capable of executing a messaging application for communicating messages. The messaging application allows for the attachment of media files within an electronic message for communicating from a sending electronic device to a receiving electronic device. For example, Apple's iOS Messenger is the native messaging application available in Apple's iPhone and iPad product line. Many different messaging applications exist, and can be native to electronic device 210 and/or 220, native to an operating system, or third-party applications. Examples of other messaging applications include, but are not limited to: Android Messages, Facebook Messenger, . . . . It should be appreciated that embodiments described herein may be implemented within any messaging application that allows for the transmission of electronic messages and media files, and is not intended to be limited to any particular messaging application.

Electronic devices 210 and 220 may be associated with a particular user. For example, a first user, may be associated with electronic device 210 and a second user, may be associated with electronic device 220. It should be appreciated that a user may be associated with multiple electronic devices, such that a message sent to a particular user may be delivered to more than one electronic device 210 or 220.

In one embodiment, remote computer system 230 is a server including a library of media files 232. A media file can be any type of file that can be rendered on an electronic device 210 or 220 (e.g., an audio file or a video file). It should be appreciated that any type of media file format can be used in accordance with the described embodiments, including but not limited to GIF, WebM, WebP, MPEG-4 (MP4), Animated Portable Network Graphics (APNG), Motion JPEG, Flash video (FLV), Windows Media video, M4V, MPEG-1 or MPEG-2 Audio Layer III (MP3), etc.

In some embodiments, electronic devices 210 and 220 are capable of accessing media file library 232 (e.g., via a graphical user interface). A user may navigate through media file library 232 to search and select a media file for transmission to a recipient. In some embodiments, access to the library of media files is accessible via a messaging application of an electronic device (e.g., a computer system or a smart phone). It should be appreciated that an electronic device may include media file library 232, or that media file library 232 may be distributed across both an electronic device and remote computer system 230. For example, a subset of media files of media file library 232 may be maintained within memory of electronic device 210 (e.g., frequently used media files) for access that does not require communication over network 240.

In various embodiments, media files are associated with at least one category (e.g., a word, sentence, or phrase) that identifies the subject matter of the media files. Categories are used for sorting media files within the media file library 232, allowing a user to locate or select a particular media file according to their desired message. It should be appreciated that a category associated with a media file can be assigned manually or automatically, and are generally indicative of the depiction presented in the media file (e.g., are searchable). In some embodiments, a category (or categories) associated with a media file may be saved as metadata of the media file. In some embodiments, a category (or categories) associated with a media file may be saved within media file library 232.

For example, a video media file depicting a person blowing out candles on a birthday cake might be associated with the category “Happy Birthday.” Other media files depicting birthday messages (e.g., a video of a movie scene with an actor making a toast accompanied with the caption “Happy Birthday!,” or an audio clip of Marilyn Monroe's famous singing of the Happy Birthday Song to President John F. Kennedy) may also be associated with the category “Happy Birthday.” It should be appreciated that a media file may be associated with multiple categories. For example, a media file of a hamster wearing a birthday hat may be associated with the “Happy Birthday” category, as well other categories such as “Animals,” “Hamsters,” or others.

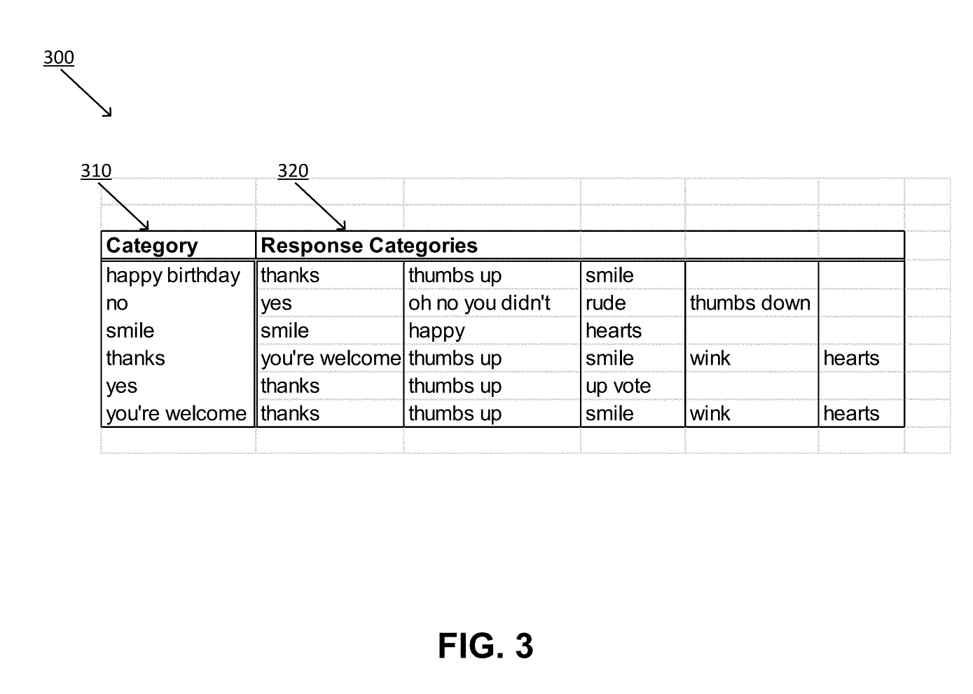

FIG. 3 illustrates a table 300 including example media file categories 310 and response categories 320, in accordance with various embodiments. Within media file library 232, media files are associated with at least one category 310. In some embodiments, media files are searchable by category 310. It should be appreciated that a media file may be associated with more than one category.

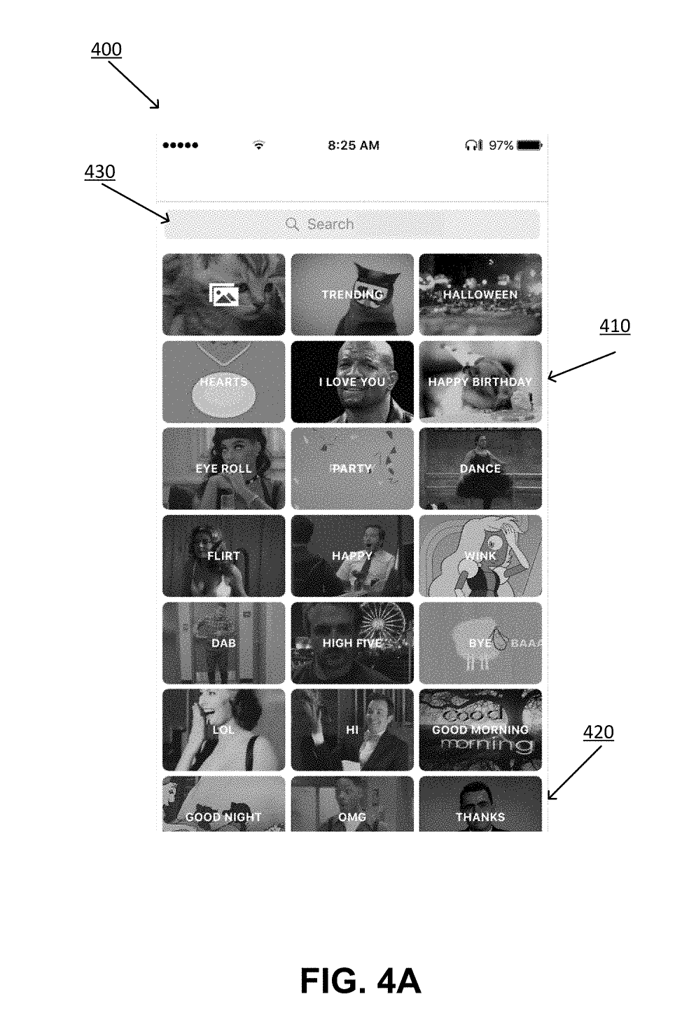

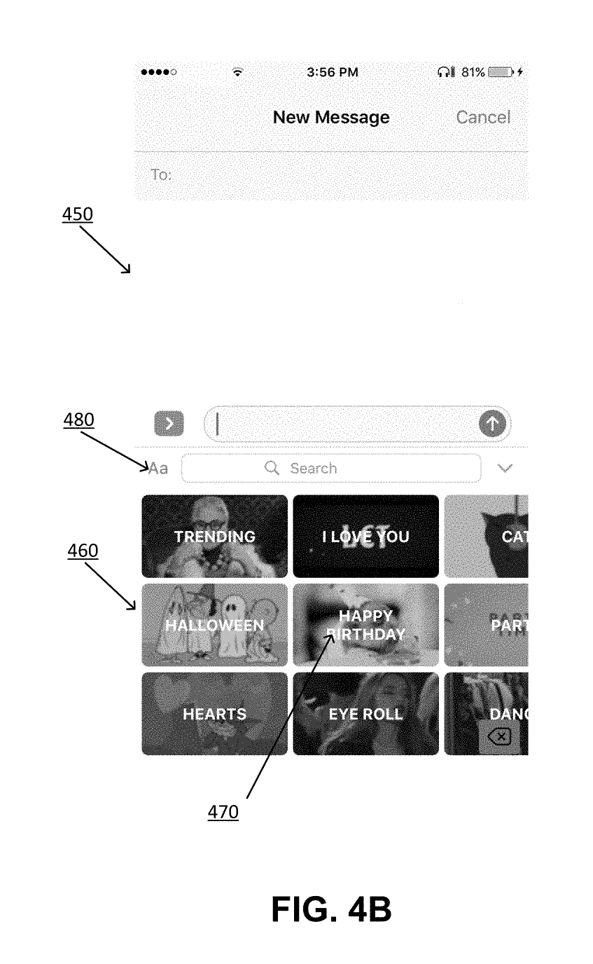

FIG. 4A illustrates an example screen shot of a graphical user interface 400 for accessing a media file library, according to one embodiment. Graphical user interface 400 includes a plurality of selectable categories, of which category 410 (“Happy Birthday”) and category 420 (“Thanks”) are two examples. By selecting a category (e.g., category 410 or 420), graphical user interface 400 presents media files for the selected category. For example, selecting category 410 causes graphical user interface 400 to display a new screen of media files for the category “Happy Birthday.”

Graphical user interface 400 also includes search field 430 for receiving text search terms for categories. For example, graphical user interface 400 may only have room to display a certain number of categories. Search field 430 allows a user to search for categories that are not displayed within graphical user interface 400. In some embodiments, graphical user interface 400 may display the most frequently accessed categories, such that less frequently accessed categories (e.g., categories that are less popular) are searchable via search field 430.

FIG. 4B illustrates an example screen shot of a messaging application 450 including a graphical user interface 460 for accessing a media file library, according to one embodiment. Graphical user interface 460 includes a plurality of selectable categories, of which category 470 (“Happy Birthday”) is one example. By selecting a category (e.g., category 470), graphical user interface 460 presents media files for the selected category. For example, selecting category 470 causes graphical user interface 460 to display a new screen of media files for the category “Happy Birthday.” Graphical user interface 460 also includes search field 480 for receiving text search terms for categories.

In accordance with some described embodiments, the categories of media files are also associated with response categories of media files. A response category is a category of media files that are most likely responsive to a media file of a particular category. For example, when a person says “happy birthday” to another person, the person whom is the object of the expression typically responds with “thanks” and/or smiles at the well-wisher. The same can be true of media files, where a recipient of a media file associated with a particular category may desire to respond to the sentiment of the media file category with a responsive media file associated with a responsive category.

With reference to FIG. 3, table 300 illustrates example response categories 320 that are associated with categories 310. For example, where a category of a sent media file is “Happy Birthday,” a response category might be “Thanks” or “Thumbs Up.” It should be appreciated that the defining of categories and response categories may be subjectively determined by a designer/administrator, and that relationships between categories and response categories may be user-defined. It should be appreciated that a media file may be associated with more than one response category. Moreover, it should be appreciated that a media file might be associated with a category or categories and a response category or categories. The illustrated categories 310 and response categories 320 of table 300 are examples, and table 300 may include any number of categories 310 and response categories 320.

In accordance with some embodiments, a selection of a media file by a user (e.g., sender) is received for transmission to another user (e.g., recipient). For example, a user operating electronic device 210 accesses media file library 232 via graphical user interface. In one embodiment, the graphical user interface for accessing media file library 232 is graphical user interface 400. In another embodiment, the graphical user interface for accessing media file library 232 is graphical user interface 460 within messaging application 450.

Embodiments described herein provide for determining at least one responsive media file to the sender's selected media file. In some embodiments, the responsive media files are determined based on the category of the selected media file. For example, upon transmission of an electronic message to a recipient including a selected media file, the category of the selected media file is determined. Response categories associated with the category of the selected media file are then determined (e.g., response categories 320 of FIG. 3). At least one media file of the response categories are selected for inclusion in the electronic message.

For example, where a category of a selected media file is “Happy Birthday,” a response category might be “Thanks” or “Thumbs Up,” as illustrated in FIG. 3. Responsive media files associated with response categories for a category of the selected media file are determined. In one embodiment, the responsive media files are selected randomly from media files within a particular response category. In other embodiments, the responsive media files are selected according to a number of uses of media files within a particular response category (e.g., popularity of media files within a response category). For example, if a particular media file is most frequently selected as a response within a response category, the particular media file may be selected as a responsive media file. It should be appreciated that the number of uses may be limited to a particular time period (e.g., the last week or the last month). It should be appreciated that any number of responsive media files can be selected, subject to the spatial or display limitations of the receiving messaging application.

An electronic message including the selected media file and any selected responsive media files is generated. The electronic message is transmitted to the recipient, where the responsive media files included in the electronic message are selectable for transmission to the sender of the electronic message within the recipients messaging application.

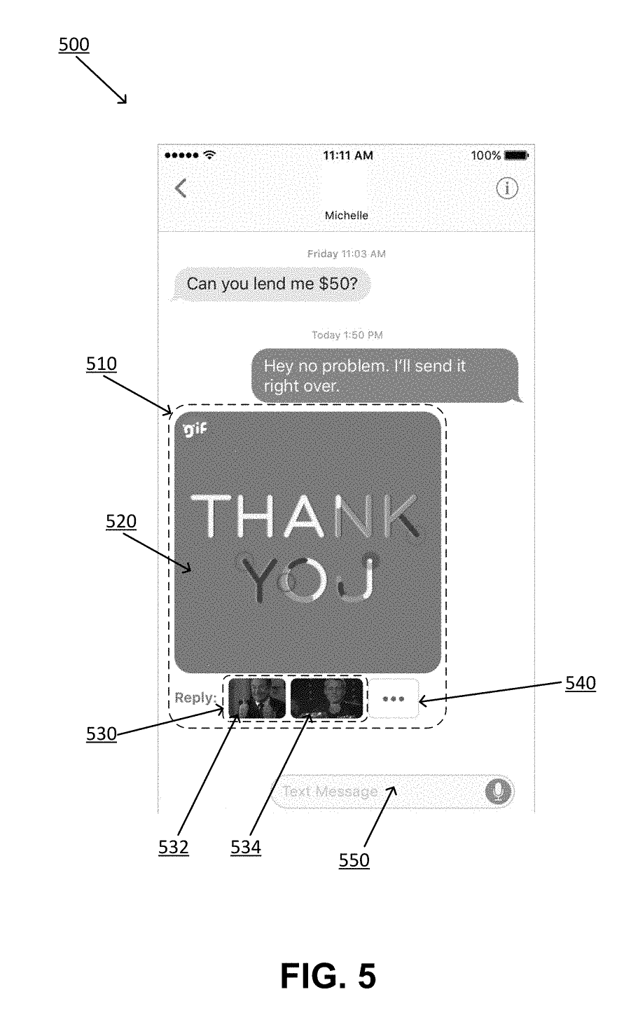

FIG. 5 illustrates an example screen shot of a messaging application 500 displaying an electronic message 510 including a selected media file 520 and two responsive media files 532 and 534, according to one embodiment. Messaging application 500 is associated with an electronic device (e.g., electronic device 210 or 220) used by a recipient of electronic message 510.

Electronic message 510 includes selected media file 520 and responsive media files 530. Selected media file 520 is selected by a sender of electronic message 510. Responsive media files 530 are automatically generated based on selected media file 520 (e.g., at remote computer system 230). As illustrated, selected media file 520 is associated with a “Thank You” category. Responsive media files 530 are presented that are responsive to the sentiment “Thank You.” For example, as illustrated, responsive media file 532 is associated with a “Thumbs Up” category and responsive media file 534 is associated with a “Wink” category.

Responsive media files 532 and 534 are selectable within electronic message 510 by a user of the electronic device executing messaging application 500. For example, a user selection of responsive media files 532 or 534 (e.g., by touching the screen of the electronic device over responsive media files 532 or 534) causes the selected responsive media file to be transmitted to or prepared for transmission (e.g., placed within field 550) to the sender of electronic message 510.

In one embodiment, electronic message 510 includes a control button 540 for accessing a media file library (e.g., media file library 232), wherein the control button 540 is presented proximate the selected media file 520 and the responsive media files 530. In one embodiment, selection of control button 540 causes the display of graphical user interface 400. In another embodiment, selection of control button 540 causes the display of graphical user interface 460 within messaging application 500. Control button 540 is useful in situations where the recipient does not desire the selection of responsive media files 530, e.g., the presented responsive media files 532 or 534 are not appropriate, or the user desires to search the media file library for a particular media file.

### Example Operations for Automatically Generating Selectable Responses to an Electronic Message

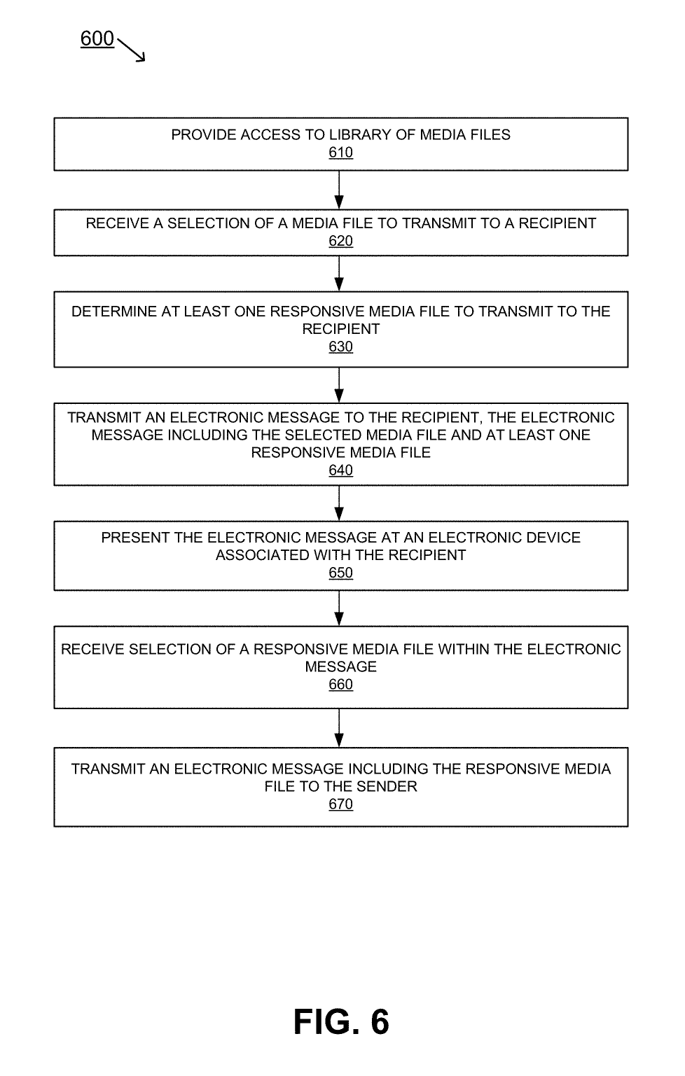

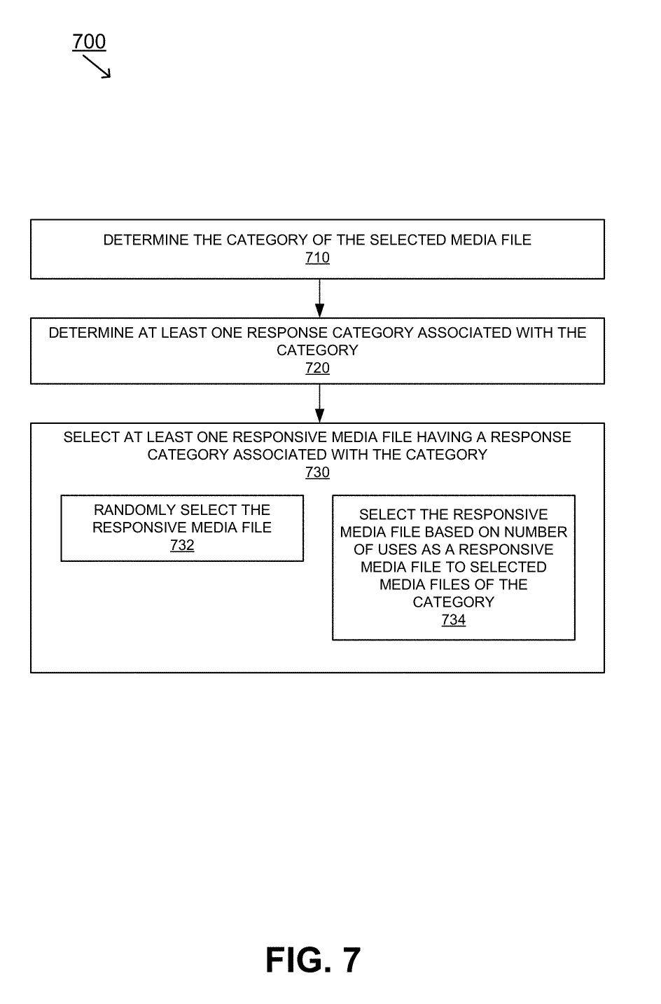

FIG. 6 illustrates a flow diagram 600 of an example method for generating a selectable response to an electronic message, according to various embodiments and FIG. 7 illustrates a flow diagram of an example method for determining a responsive media file to transmit to a recipient, according to various embodiments. Procedures of this method may be described with reference to elements and/or components of various figures described herein. It is appreciated that in some embodiments, the procedures may be performed in a different order than described, that some of the described procedures may not be performed, and/or that one or more additional procedures to those described may be performed. Flow diagrams 600 and 700 include some procedures that, in various embodiments, are carried out by one or more processors under the control of computer-readable and computer-executable instructions that are stored on non-transitory computer-readable storage media. It is further appreciated that one or more procedures described in flow diagrams 600 and 700 may be implemented in hardware, or a combination of hardware with firmware and/or software.

At procedure 610 of flow diagram 600, in accordance with one embodiment, access is provided to a library of media files (e.g., media file library 232) including a plurality of media files. In one embodiment, access to the library of media files is provided via a graphical user interface of an electronic device (e.g. electronic device 210), wherein media files of the plurality of media files are associated with a category, and wherein a category is associated with at least one response category. It should be appreciated that any type of media file format can be used in accordance with the described embodiments, including but not limited to GIF, WebM, WebP, MPEG-4 (MP4), Animated Portable Network Graphics (APNG), Motion JPEG, Flash video (FLV), Windows Media video, M4V, MPEG-1 or MPEG-2 Audio Layer III (MP3).

At procedure 620, a selection of a media file from a plurality of media files to transmit to a recipient is received. In one embodiment, the selected media file is associated with a category, and the category is associated with at least one response category.

At procedure 630, at least one responsive media file to transmit to the recipient is determined, wherein the at least one responsive media file is based at least in part on the selected media file. In accordance with various embodiments, procedure 630 may be implemented according to flow diagram 700 of FIG. 7.

FIG. 7 illustrates a flow diagram 700 of an example method for determining a responsive media file to transmit to a recipient, according to various embodiments. At procedure 710 of flow diagram 700, a category of the selected media file is determined. At procedure 720, at least one response category associated with the category is determined.

At procedure 730, one or more responsive media files from media files of the plurality of media files having the at least one response category associated with the category is selected. In one embodiment, as shown at procedure 732, the one or more responsive media files are randomly selected from media files having the at least one response category associated with the category. In another embodiment, as shown at procedure 734, the one or more responsive media files are selected based on a number of uses of the media file as a responsive media file to media files of the category.

With reference to FIG. 6, at procedure 640, an electronic message is transmitted to the recipient, where the electronic message includes the selected media file and one or more responsive media files. The one or more responsive media file are selectable within the electronic message by the recipient for transmission to a sender of the electronic message.

In one embodiment, as shown at procedure 650, the electronic message (e.g., electronic message 510) is presented at a second electronic device associated with the recipient (e.g., electronic device 220), such that the selected media file (e.g., selected media file 520) and the one or more responsive media files (e.g., responsive media files 532 and 534) are displayed at the second electronic device. In one embodiment, a control button for accessing a library of media files is presented, wherein the control button is presented proximate the selected media file and the one or more responsive media files.

In one embodiment, as shown at procedure 660, a selection of a responsive media file within the electronic message is received. In one embodiment, as shown at procedure 670, responsive to the selection of a responsive media file within the electronic message, a second electronic message is transmitted to the sender of the electronic message, wherein the second electronic message includes the selected responsive media file.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. Many aspects of the different example embodiments that are described above can be combined into new embodiments. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A computer-implemented method for generating a selectable response to an electronic message, the method comprising:
receiving, at an electronic device, a selection of a media file from a plurality of media files to transmit to a recipient;
determining at least one responsive media file to transmit to the recipient, wherein the at least one responsive media file is based at least in part on the selected media file; and
transmitting an electronic message to the recipient, the electronic message comprising the selected media file and the at least one responsive media file, wherein the at least one responsive media file is selectable within the electronic message by the recipient for transmission to a sender of the electronic message.

2. The method of claim 1, wherein the selected media file and the at least one responsive media file are Graphics Interchange Format (GIF) files, Animated Portable Network Graphics (APNG) files, or WebP files.

3. The method of claim 1, further comprising:
providing access to a library of media files comprising the plurality of media files at a graphical user interface of the electronic device, wherein media files of the plurality of media files are associated with a category, and wherein a category is associated with at least one response category.

4. The method of claim 1, wherein the selected media file is associated with a category, and wherein the category is associated with at least one response category.

5. The method of claim 4, wherein the determining the at least one responsive media file to transmit to the recipient comprises:
determining the category of the selected media file;
determining at least one response category associated with the category; and
selecting the at least one responsive media file from media files of the plurality of media files having the at least one response category associated with the category.

6. The method of claim 5, wherein the selecting the at least one responsive media file from the media files of the plurality of media files having the at least one response category associated with the category comprises:
randomly selecting the at least one responsive media files as a media file of the plurality of media files having the at least one response category associated with the category.

7. The method of claim 5, wherein the selecting the at least one responsive media file from the media files of the plurality of media files having the at least one response category associated with the category comprises:
selecting the at least one responsive media files as a media file of the plurality of media files having the at least one response category associated with the category and based on a number of uses of the media file as a responsive media file to media files of the category.

8. The method of claim 1, further comprising:
presenting the electronic message at a second electronic device associated with the recipient, such that the selected media file and the at least one responsive media file are displayed at the second electronic device.

9. The method of claim 8, further comprising:
receiving a selection of the at least one responsive media file within the electronic message; and
responsive to the selection of the at least one responsive media file within the electronic message, transmitting a second electronic message to the sender of the electronic message, wherein the second electronic message comprises the at least one responsive media file.

10. The method of claim 8, further comprising:
presenting a control button for accessing a library of media files, wherein the control button is presented proximate the selected media file and the at least one responsive media file.

11. A non-transitory computer readable storage medium having computer readable program code stored thereon for causing a computer system to perform a method for generating a selectable response to an electronic message, the method comprising:
receiving, at an electronic device, a selection of a media file from a plurality of media files to transmit to a recipient;
determining a plurality of responsive media files to transmit to the recipient, wherein the plurality of responsive media files is based at least in part on the selected media file; and
transmitting an electronic message to the recipient, the electronic message comprising the selected media file and the plurality of responsive media files, wherein the plurality of responsive media files is selectable within the electronic message by the recipient for transmission to a sender of the electronic message.

12. The non-transitory computer readable storage medium of claim 11, wherein the selected media file and the plurality of responsive media files are Graphics Interchange Format (GIF) files, Animated Portable Network Graphics (APNG) files, or WebP files.

13. The non-transitory computer readable storage medium of claim 11, the method further comprising:
providing access to a library of media files comprising the plurality of media files at a graphical user interface of the electronic device, wherein media files of the plurality of media files are associated with a category, and wherein a category is associated with at least one response category.

14. The non-transitory computer readable storage medium of claim 11, wherein the selected media file is associated with a category, and wherein the category is associated with at least one response category.

15. The non-transitory computer readable storage medium of claim 14, wherein the determining the plurality of responsive media files to transmit to the recipient comprises:
determining the category of the selected media file;
determining at least one response category associated with the category; and
selecting the plurality of responsive media files from media files of the plurality of media files having the at least one response category associated with the category.

16. The non-transitory computer readable storage medium of claim 11, the method further comprising:
presenting the electronic message at a second electronic device associated with the recipient, such that the selected media file and the plurality of responsive media files are displayed at the second electronic device.

17. The non-transitory computer readable storage medium of claim 16, the method further comprising:
receiving a selection of a responsive media file of the plurality of responsive media files within the electronic message presented at the second electronic device; and
responsive to the selection of the responsive media file within the electronic message, transmitting a second electronic message to the sender of the electronic message, wherein the second electronic message comprises the responsive media file.

18. The non-transitory computer readable storage medium of claim 16, the method further comprising:
presenting a control button for accessing a library of media files, wherein the control button is presented proximate the selected media file and the plurality of responsive media files.

19. An electronic device comprising:
an display device;
a data storage unit; and
a processor coupled with the data storage unit and the display device, the processor configured to:
provide access to a library of media files comprising a plurality of media files at a graphical user interface of the electronic device via the display device, wherein media files of the plurality of media files are associated with a category, and wherein a category is associated with at least one response category;
receive a selection of a media file from the plurality of media files to transmit to a recipient at the graphical user interface;
determine the category of the selected media file;
determine at least one response category associated with the category of the selected media file;
select at least one responsive media file from media files of the plurality of media files having the at least one response category associated with the category; and
transmit an electronic message to the recipient, the electronic message comprising the selected media file and the at least one responsive media file, wherein the at least one responsive media file is selectable within the electronic message by the recipient for transmission to a sender of the electronic message.
